(19) United States
(12) Patent Application Publication
(10) Pub. No.: US 2005/0211110 A1
(43) Pub. Date: Sep. 29, 2005

(54) Self cleaning barbecue roasting hood

(76) Inventor: Tse-Peng Lin, Tai Ping City (TW)

Correspondence Address: TSE-PENG LIN, No. 10, Alley 40, Lane 19, Sec. 3, Chung Shan Road, Tai Ping City, Taichung Hsien, 411, TW

(21) Appl. No.: 10/807,112

(22) Filed: Mar. 24, 2004

(51) Int. Cl. A23L 1/00

(52) U.S. Cl. 99/476

(57) ABSTRACT

A roasting hood for a barbecue, the roasting hood being locatable over a cooking area of the barbecue, the roasting hood including an inner surface covered with a catalytic coating, wherein when the barbeque is in use with the roasting hood located thereon, at least the inner surface of the roasting hood is heated such that any food splatter, grease, juices, fats and so on projected onto said inner surface are at least substantially burnt off from the catalytic coating covering the inner surface of the roasting hood.

### BACKGROUND OF THE INVENTION

1. Field of Invention

The present invention is generally directed to outdoor cooking equipment, and in particular to roasting hoods for barbecues. A roasting hood for a barbecue including an inner surface covered with a catalytic coating, wherein when the barbeque is in use with the roasting hood located thereon, at least the inner surface of the roasting hood is heated such that any food splatter, grease, juices, fats and so on projected onto said inner surface are at least substantially burnt off from the catalytic coating covering the inner surface of the roasting hood. This ensures that little to no cleaning of the inner surface of the roasting hood is required after use of the barbecue.

2. Description of the Prior Art

Many barbecue manufacturers now offer roasting hoods as an accessory for barbecues, or offer barbecues incorporating integrated roasting hoods. These roasting hoods are typically made from either painted or vitreous enameled mild steel sheet metal. Alternatively, roasting hoods can be made from stainless steel sheet metal. The roasting hood is typically fabricated using sheet metal manufacturing processes. The roasting hood sits over the top of the cooking area of the barbecue to provide an internal cooking volume for the barbecue. The use of a roasting hood adds to the overall versatility of the barbecue allowing it to cook a greater variety of foods using cooking methods including roasting, baking, and smoking as well as barbecuing.

### SUMMARY OF THE PRESENT INVENTION

A common problem associated with barbecues is the difficulty in cleaning them after they have been used. The cooking process can result in an accumulation of because of the accumulation of food splatter, grease, juices and oils as well as charcoal on the cooking surface and grills and on different surfaces of the barbecue. Considerable effort is therefore required to clean the barbecue after its use. Harsh cleaning chemicals or detergents and abrasive products such as steel wool are usually required to clean the barbecue properly. The amount of cleaning required is compounded when a roasting hood is used because of the accumulation of food spatter, grease, juices and fat on the underside of the roasting hood during the cooking process. It would be advantageous to be able to avoid or at least minimize the need to regularly clean the roasting hood of the barbecue.

To this end, it is an object of the present invention to provide a roasting hood that alleviates this problem.

With this in mind, according to one aspect of the present invention, there is provided a roasting hood for a barbecue, the roasting hood being locatable over a cooking area of the barbecue, the roasting hood including an inner surface covered with a catalytic coating, wherein when the barbeque is in use with the roasting hood located thereon, at least the inner surface of the roasting hood is heated such that any food splatter, grease, juices, fats and so on projected onto said inner surface are at least substantially burnt off from the catalytic coating covering the inner surface of the roasting hood. This ensures that little to no cleaning of the inner surface of the roasting hood is required after use of the barbecue.

### DETAILED DESCRIPTION OF THE PREFERRED EMBODIMENTS

The catalytic coating may be formed by a first ground coat followed by a second cover coat for providing the final catalytic coating. Each said coat may be sprayed or otherwise applied onto the inner surface of the roasting hood.

The first ground coating may be provided by porcelain enamel which may be sprayed onto the cleaned steel inner surface of the roasting hood. This coating may then be fired, typically at about 830 deg C.

The second cover coating may be provided by premixing a blend of frit, refractory powders, suspended agents and electrolytes. This blend may be shear mixed with water prior to being applied to the inner surface of the roasting hood. This coating may then be dried and then fired to form the final catalytic coating. The cover coating may typically be fired at about 820 deg C. The coating may provide a spotted surface profile which acts to increase the abrasion resistance of the coating by creating impact points against which particles of grease and the same can be broken up when projected against the catalytic coating during the cooking process.

The effectiveness of the catalytic coating at burning off foreign matter deposited thereon improves at higher temperatures. To this end, the roasting hood may include an inner and outer skin, with the inner skin providing the inner surface upon which the catalytic coating is applied. An air gap or an insulating material may be provided between the inner and outer skins of the roasting hood.

This two skin construction of the roasting hood allows for the inner skin to be heated at a significantly higher temperature then the outer skin. This facilitates the effectiveness of the catalytic coating in burning off the foreign matter accumulated thereon.

The twin skin construction also ensures that the outer skin remains at a relatively low temperature leading to improve safety in the use of this roasting hood. It also facilitates the use of stainless steel on the outer skin because excessive heating of the stainless steel can lead to its discolorations. These excessive temperatures are avoided by using the twin skin construction for the roasting hoods.

Furthermore, the twin skin construction provides for a more rigid construction of the roasting hood such that it will not be as flimsy as many single skin roasting hoods.

According to another aspect of the present invention, there is provided a barbecue including a roasting hood as described above.

The present invention therefore provides a “self cleaning” effect for the inner surface of the roasting hood. Heating of that inner surface facilitates the burning off of foreign matter such as food splatter, grease, juices and oils projected onto the catalytic coating during the cooking process. This burning off effect can be further facilitated by turning the barbecue on to a higher temperature for a few minutes after the conclusion of the cooking process.

1. A roasting hood for a barbecue, the roasting hood being locatable over a cooking area of the barbecue, the roasting hood including an inner surface covered with a catalytic coating, wherein when the barbeque is in use with the roasting hood located thereon, at least the inner surface of the roasting hood is heated such that any food splatter, grease, juices, fats and so on projected onto said inner surface are at least substantially burnt off from the catalytic coating covering the inner surface of the roasting hood.

2. A roasting hood according to claim 1, wherein the roasting hood includes an inner and outer skin, with the inner skin providing the inner surface upon which the catalytic coating is applied.

3. A roasting hood according to claim 1 or 2, wherein the catalytic coating includes a first ground coat and a second cover coat provided by a blend of frit, refractory powders, suspended agents and electrolytes, said coating being fired to form the catalytic coating.

4. A roasting hood according to claim 3, wherein the first ground coat is provided by a fired porcelain enamel.

5. A barbecue including a roasting hood as claimed in any one of the preceding claims.
